(19) United States
(12) Patent Application Publication
(10) Pub. No.: US 2010/0057550 A1
(43) Pub. Date: Mar. 4, 2010

(54) METHODS AND SYSTEMS FOR DETERMINING REWARDS IN NETWORK-BASED APPLICATIONS

(75) Inventor: Thuc Trung Nguyen, San Jose, CA (US)

Correspondence Address: SCHWEGMAN, LUNDBERG & WOESSNER/EBAY, P.O. BOX 2938, MINNEAPOLIS, MN, 55402, US

(73) Assignee: eBay, Inc., san jose, CA (US)

(21) Appl. No.: 12/548,144

(22) Filed: Aug. 26, 2009

Related U.S. Application Data
(60) Provisional application No. 61/091,769, filed on Aug. 26, 2008.

(51) Int. Cl. G06Q 30/00; G06Q 50/00

(52) U.S. Cl. 705/14.25; 705/14.35

(57) ABSTRACT

A reward program that includes identifying a seller from a plurality of sellers in a network-based marketplace based on a set of criteria. When a seller is identified to qualify for a reward program, one or more listings of the seller may be promoted. The set of criteria may include seller's rating information. The set of criteria may also include other information relating to volume or activities.

### CROSS-REFERENCE TO RELATED APPLICATIONS

This application claims priority benefit of U.S. Provisional Patent Application No. 61/091,769, entitled, “Methods and Systems for Determining Rewards in Network-Based Applications,” filed Aug. 26, 2008, which is hereby incorporated by reference in its entirety.

### TECHNICAL FIELD

The present application relates generally to the technical field of data processing and, in a specific exemplary embodiment, to a method and system of rewarding participants in network-based applications.

### BACKGROUND

Network-based marketplace applications generally enable one or more sellers to display their merchandises or services as listings. The listings may be displayed via some listing interfaces. The listing interfaces may include options to enable potential buyers to manipulate how the listings can be viewed. For example, the potential buyers may perform a search to look for desired listings. The resulting listings may be displayed in certain default sequence, and they may be sorted by listing date, price, etc. Some network-based marketplace applications may enable the sellers to pay premium listing fees so that their listings may be more visible to the potential buyers.

### BRIEF DESCRIPTION OF THE DRAWINGS

Various ones of the appended drawings merely illustrate exemplary embodiments of the present invention and cannot be considered as limiting its scope.

FIG. 1 illustrates a network diagram depicting a system, according to an exemplary embodiment, having a client-server architecture.

FIG. 2 illustrates a operation diagram showing a network-based marketplace and payment applications in an exemplary embodiment.

FIG. 3 illustrates a high-level diagram of reward applications, in accordance with some exemplary embodiments.

FIG. 4 is a flow chart illustrating an example method for selecting participants of the network-based marketplace for reward programs, in accordance with some exemplary embodiments.

FIG. 5 is a flowchart illustrating an example method for maintaining qualification in the reward programs, in accordance with some exemplary embodiments.

FIG. 6 illustrates a diagrammatic representation of a machine in the form of a computer system within which a set of instructions, for causing the machine to perform any one or more of the methodologies discussed herein, may be executed, according to an exemplary embodiment.

### DETAILED DESCRIPTION

The description that follows includes illustrative systems, methods, techniques, instruction sequences, and computing machine program products that embody the present invention. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on an electronic marketplace environment, the embodiments are given merely for clarity in disclosure. Thus, any type of electronic commerce or electronic business system and method, including various system architectures, may employ various embodiments of the adaptive risk-based verification system and method described herein and is considered as being within a scope of the present invention.

For some exemplary embodiments, methods and systems to reward participants in network-based marketplace are described. Participants who are highly rated may qualify for rewards. The rewards may be in the form of listing promotion. The rewards may be limited for a period of time. Qualification for the rewards may be withdrawn before the expiration of the period of time.

In the following description, for purposes of explanation, numerous specific details are set forth in order to provide a thorough understanding of the present application. It will be evident, however, to one skilled in the art that the present application may be practiced without these specific details.

The description may include terms such as “up,” “down,” “upper,” “lower,” “first,” “second,” etc. Such terms are used for descriptive purposes only and are not to be construed as limiting. The elements, materials, geometries, dimensions, and sequences of operations may all be varied to suit particular applications. Parts of some embodiments may be included in, or substituted for, those of other embodiments. While examples of dimensions and ranges are considered typical, the various embodiments are not limited to such dimensions or ranges.

### Architecture

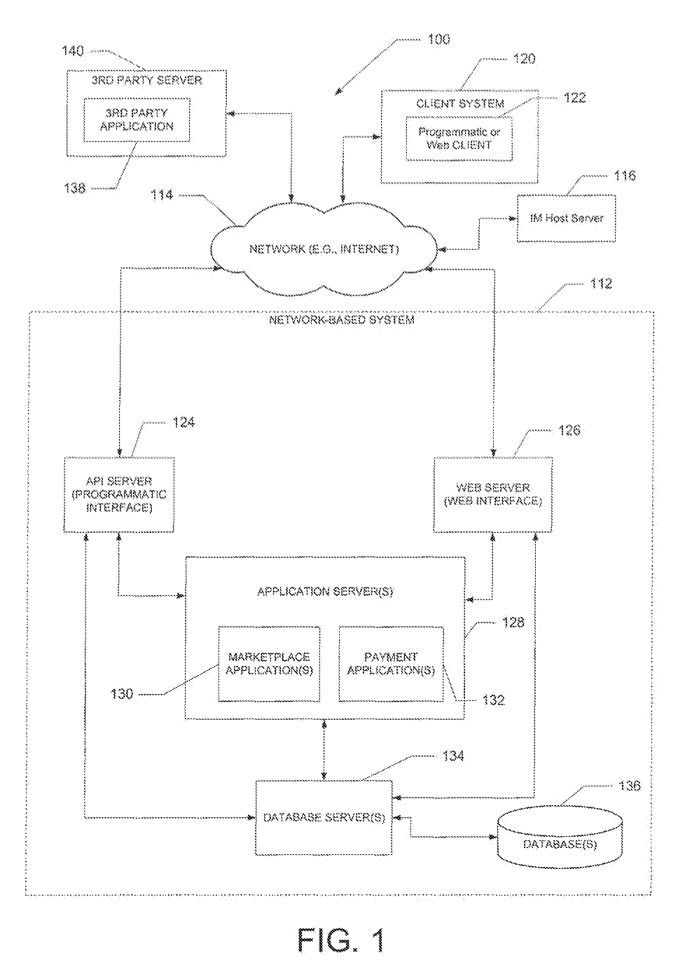

FIG. 1 illustrates a network diagram depicting a system 100 having a client-server architecture, according to an exemplary embodiment of the present invention. A system, in the exemplary form of a network-based system 112, provides server-side functionality, via a network 114 (e.g., the Internet, a public or private telephone network (wireline or wireless), a private wireless network using technologies such as Bluetooth®, IEEE 802.11x, or other network types) to one or more clients. FIG. 1 illustrates, for example, a programmatic/web client 122 may include a browser (e.g., the Internet Explorer® browser developed by Microsoft® Corporation of Redmond, Wash.), a device application, or a programmatic client executing on a client system 120, for example, on a network-based device. Further, while the system 100 shown in FIG. 1 employs a client-server architecture, embodiments are of course not limited to such an architecture, and could equally well find applications in a distributed, peer-to-peer, or other type of system architecture.

The network 114 may include a mobile telephone network, a wireless wide area network (WWAN), a wireline telephone network, a wireless local area network (wireless LAN or WLAN), a wireless Metropolitan Area Network (MAN), or a wireless personal area network (PAN) (e.g., a Bluetooth® network). Other network-based technologies that may be used to connect include PON, VSAT satellite, Micro-impulse Radar, Radio Frequency identification (RFID), UltraWide Band, or Infrared. (Each of these technologies is known independently in the art.) The network-based device may connect to the web using mobile internet exchange, such as, for example, Wireless Application Protocol (WAP) or Hypertext Transport Protocol (HTTP).

The client system 120 (or network-based device(s)), may include a mobile device, a palmtop computer, a laptop computer, a desktop computer, a personal digital assistant, a cellular telephone, a communications device, a wireless telephone, a land-line telephone, a control system, a camera, a scanner, a television, television cable, a telephone with a web browser, a facsimile machine, a printer, a pager, or a personal trusted device. There may be one or more instantiations of the client system 120.

The client system 120 may further include a card, such as a smart card, a magnetic card, or a key card. The device may include a telephone or any device capable of Short Messaging Service (SMS) messaging, instant messaging (IM), text messaging, multimedia messaging service (MMS), or generating audio tones, such as dual-tone multi-frequency (DTMF) tones. The device may be browser-enabled. The client system 120 may enable mobile videophone communications, digital television signals, or digital radio signals. The device can include a receiver to receive near field communications. For some exemplary embodiments, the client system 120 may be used by a consumer to authorize a payment facilitator to pay a portion of an electronic invoice.

The client system 120 may engage in an interactive message or open communication session, such as SMS, IM, electronic mail, xHTML, XML, Wireless Application Protocol (WAP), web, interactive voice response (IVR), or other mobile interfaces. The interactive messaging or open communication session may involve multiple technology modalities. For example, the client user may engage the system via instant messaging (IM) and receive a responsive communication from the network-based system 112 via e-mail with an embedded hyperlinked Uniform Resource Locator (URL) directing the client to a WAP or web page or via a telephone call. A hyperlinked URL may be delivered directly to the client device from one or more application servers 128 of the network-based system 112 and may be used to access a web site or a microbrowser, such as a WAP site.

Turning now specifically to the network-based system 112, the one or more application servers 128 may host one or more marketplace applications 130 and one or more payment applications 132.

The one or more marketplace applications 130 may provide a number of marketplace functions and services to client users, such as a buyer, or to third parties, such as sellers, vendors, or any user that accesses the network-based system 112. The one or more marketplace applications 130 may provide a number of offering mechanisms and price-setting mechanisms. For example, a seller may list goods or services for sale, a seller may promote his or her offers, a buyer can express interest in or indicate a desire to purchase such goods or services or to donate, and a price can be set for a transaction pertaining to the goods or services.

The one or more payment applications 132 can provide a number of payment services and functions to users. While the one or more marketplace applications 130 and payment applications 132 are shown in FIG. 1 to both form part of the network-based system 112, it will be appreciated that, in alternative embodiments, the one or more payment applications 132 may form part of a payment service that is separate and distinct from the network-based system 112.

In an instance where the client system 120 accesses the marketplace applications 130 and the payment applications 132, the client system 120 may use an “instant messaging” service via an IM host server 116 for communication via substantially instant messaging. In various exemplary embodiments, the IM host server 116 may be selected from a group including, for example, Skype®, Yahoo® IM, AIM® of AOL®, MSN® Messenger of Microsoft® Corporation, and ICQ® of the ICQ Network. The IM host server 116 may be included within the network-based system 112 and therefore enable secure transactions with the application servers 128, and specifically may be included within the payment applications 132.

The client system 120 may access the application servers 128, such as various ones of the marketplace applications 130 and the payment applications 132, via a system interface. The system interface between the client system 120 and the marketplace applications 130 and the payment applications 132 may include a programmatic interface supported by an Application Program Interface (API) server 124 or a web interface supported by a web server 126. The web interface may include a web browser or any microbrowser, such as xHTML or WAP. Similarly, the programmatic/web client 122 accesses the various services and functions provided by the application servers 128, via the programmatic interface provided by the API server 124 or the web server 126. The programmatic/web client 122 may, for example, be a seller application (e.g., TurboLister® application produced by eBay, Inc. of San Jose, Calif.) to enable sellers to author and manage listings on the network-based system 112 in an off-line manner, and to perform batch-mode communications between the programmatic/web client 122 and the network-based system 112.

In an additional embodiment, an application supported by one or more applications of the application servers 128 may be downloadable to the network-based device. The device(s) may host the interface associated with the one or more applications of the application servers 128. The interface on the device may be an API interface, an MS interface, a web interface, or another appropriate communication interface. Consumer wireless device platforms, such as Java 2 Platform Micro Edition (J2ME), J2SE and J2EE allow developers to use Java and a wireless toolkit to create applications and programs for the client system 120. The J2ME interface may include an application programming interface (API) for the device. The application of the programmatic client may also access the Internet using, for example, Binary Runtime Environment for Wireless (BREW).

The programmatic/web client 122 executed on the client system 120 may access the application servers 128 via the web interface of the web server 126. The programmatic/web client 122 may be selected on the client system 120 that may cause the Internet to be launched in a background process. The programmatic/web client 122 may additionally or alternatively access the application servers 128 via the programmatic interface of the API server 124. In a specific exemplary embodiment, the downloaded application described herein may include the programmatic/web client 122.

The client system 120 may host the interface associated with one or more of the payment applications 132 of the application servers 128. The programmatic/web client 122 may be associated with a financial service provider (FSP) of the payment applications 132. In an additional embodiment, the programmatic/web client 122 may be associated with a third party application 138 of a third party server 140. The third party application 138 may provide, for example, one or more promotional, marketplace, or payment functions that are supported by the relevant applications of the network-based system 112. For some exemplary embodiments, the third party application 138 may generate an electronic invoice and transmit the electronic invoice to the payment applications 132 for processing.

The payment applications 132 or the FSP may operate independently of the third party. In other embodiments, the payment applications 132 or the FSP may be related to the third party.

The payment applications 132 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 130. The payment applications 132, for example, the financial service provider (FSP), may also extend credit to the user, or may also have access to other funding sources to complete transactions such as, for example, a credit card, a bank account, or a credit line. The FSP may operate using the payment applications 132.

The third party or vendor may receive, from the payment applications 132 or the FSP, information regarding a requested payment transaction for a product, a service, or a donation amount, information regarding the shipment address specified by the client user, and payment confirmation. The payment applications 132 or the financial service provider may secure financial information of the client user with respect to the third party. The FSP may not be sharing the financial information of the client user with the third party. For example, the payment may be received by the third party exclusive of the payment method or financial information of the client user, including credit card information, bank information or other client user account information.

The network-based system 112 and various ones of the marketplace applications 130 and the payment applications 132 may also be implemented as standalone software programs, which do not necessarily have networking capabilities. In this example, the client system 120 may be directly connected to the marketplace applications 130 or the payment applications 132, without using the network 114. In other examples, the network-based system 112 may be any online marketplace (e.g., eBay marketplace, etc.)

The application servers 128 may be coupled to one or more database servers 134 that facilitate access to one or more databases 136. The application servers 128 may have access to the one or more databases 136 having, for example, personal user account information. The user account information may include payment information associated with the client user and an address destination of the client user, for example.

The programmatic/web client 122 may operate a program supported by the one or more database servers 134. The one or more database servers 134 may support one or more account information links on a user interface of the network-based device, for example, using the programmatic/web client 122. By accessing the one or more database servers 134, the client user may add, amend, or delete account information of the client user, among other information. In an exemplary embodiment, the client user may select a default shipment address and a default payment method in the payment applications 132 discussed herein. Depending on whether goods are purchased, a service is requested, a donation is made, or a promotion is selected, a default shipment address, for example, an electronic mail address or a residential address, a business addresses, or a P.O. Box, may be selected by the client user in the payment applications 132. One of the default payment methods may include direct transfers from system account balances, internal credit, a gift certificate, a bank account, a debit card, buyer credit, or a credit card.

The payment applications 132 may transfer funds (or other value) between users. The payment applications 132 may, responsive to the server(s) receiving a payment transaction request from the user, transfer a payment from the user to the third party. The payment may automatically be transferred as discussed herein.

For some exemplary embodiments, the payment applications 132 may be associated with a payment facilitator (e.g., PayPal®), the third party server 140 may be associated with a merchant (e.g., a restaurant), and the users may be consumers or clients of the merchant. For some exemplary embodiments, the payment transaction request from the user may be associated with a transaction code generated by the payment applications 132 and an electronic invoice generated by the third party server 140.

In an exemplary embodiment of the present invention, a buyer or a consumer may be a client user that submits a purchase request, such as a purchase initiation code associated with a promotion offer, for example, or associated with an offer of an online marketplace or another marketplace medium, to the FSP. The user may submit the purchase initiation code through the network-based device while in an established communication session with the payment applications 132. The communication session may include an instant message communication session, or a telephone call, or a website, for instance. The user may be requested to submit verification of identity, such as a password and usemame, upon making the purchase request, as discussed herein. Payment in connection with the request may be made using the FSP, for example, by debiting a first user account and crediting a second user account (or vendor account), accordingly. A means for transferring the payment is, for example, through the payment applications 132.

### Application Server(s)

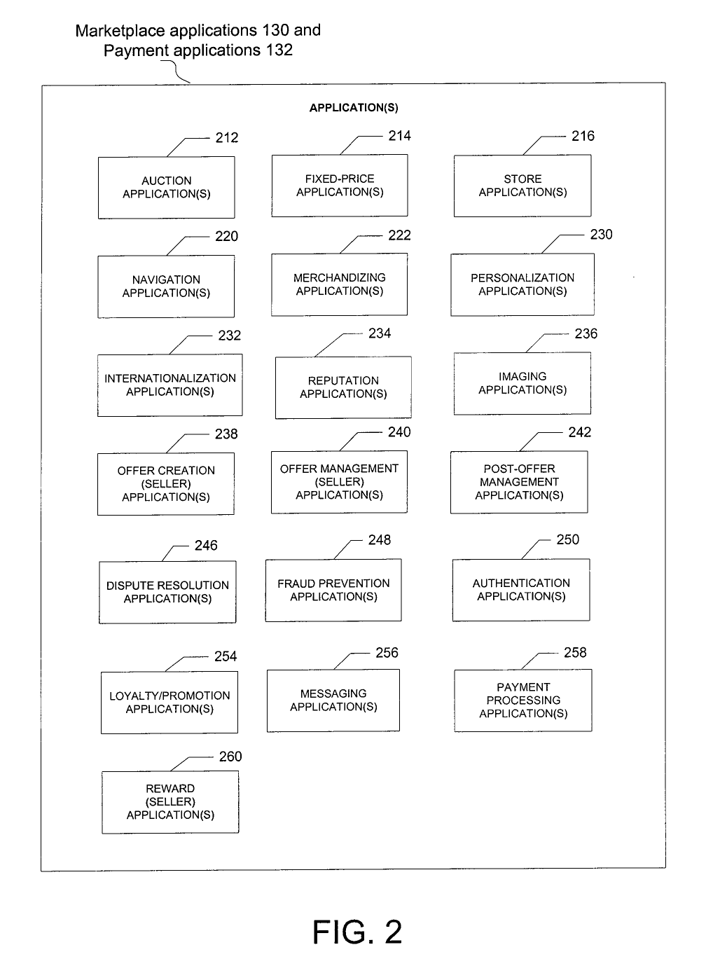

FIG. 2 illustrates an operational diagram showing the marketplace applications 130 and the payment applications 132 that are part of the network-based system 112, in an exemplary embodiment of the present invention. In this embodiment, the marketplace applications 130, and the payment applications 132 may be hosted by the application servers 128 of the network-based system 112. The marketplace applications 130 and the payment applications 132 may be hosted on dedicated or shared server machines (not shown) that are communicatively coupled to enable communications between server machines. The applications themselves may be communicatively coupled (e.g., via appropriate interfaces) to each other and to various data sources, so as to allow information to be passed between the applications or so as to allow the applications to share and access common data.

The marketplace applications 130 are shown to include at least one or more auction applications 212 which support auction-format listing and price setting mechanisms (e.g., English, Dutch, Vickrey, Chinese, Double, Reverse auctions, etc.). The auction applications 212 may also provide a number of features in support of such auction-format listings, such as a reserve price feature whereby a seller may specify a reserve price in connection with a listing and a proxy-bidding feature whereby a bidder may invoke automated proxy bidding. The auction-format offer in any format may be published in any virtual or physical marketplace medium and may be considered the point of sale for the commerce transaction between a seller and a buyer (or two users).

One or more fixed-price applications 214 support fixed-price listing formats (e.g., the traditional classified advertisement-type listing or a catalogue listing) and buyout-type listings. Specifically, buyout-type listings (e.g., including the Buy-it-Now® (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Applications of the one or more application servers 128 may include one or more store applications 216 that allow a seller to group listings within a “virtual” store. The virtual store may be branded and otherwise personalized by and for the seller. Such a virtual store may also offer promotions, incentives, and features that are specific and personalized to a relevant seller.

Navigation of the online marketplace may be facilitated by one or more navigation applications 220. For example, a search application (as an example of a navigation application) may enable key word searches of listings published via the network-based system 112. A browse application may allow users to browse various category, catalogue, or inventory data structures according to which listings may be classified within the network-based system 112. Various other navigation applications may be provided to supplement the search and browsing applications.

One or more merchandizing applications 222 support various merchandising functions that are made available to sellers to enable sellers to increase sales via the network-based system 112. The merchandizing applications 222 also operate the various merchandising features that may be invoked by sellers and may monitor and track the success of merchandising strategies employed by sellers.

One or more personalization applications 230 allow users of the network-based system 112 to personalize various aspects of their interactions with the network-based system 112. For example, a user may, utilizing an appropriate one or ones of the personalization applications 230, create a personalized reference page at which information regarding transactions to which the user is (or has been) a party may be viewed. Further, the personalization applications 230 may enable a third party to personalize products and other aspects of their interactions with the network-based system 112 and other parties, or to provide other information, such as relevant business information, about themselves.

The marketplace applications 130 may include one or more internationalization applications 232. In one embodiment, the network-based system 112 may support a number of marketplaces that are customized for, for example, specific geographic regions. A version of the network-based system 112 may be customized for the United Kingdom whereas another version of the network-based system 112 may be customized for the United States. Each of these versions may operate as an independent marketplace, or may be customized (or internationalized) presentations of a common underlying marketplace. The network-based system 112 may accordingly include a number of the internationalization applications 232 that customize information (or the presentation of information) by the network-based system 112 according to predetermined criteria (e.g., geographic, demographic, or marketplace criteria). For example, the internationalization applications 232 may be used to support the customization of information for a number of regional websites that are operated by the network-based system 112 and are accessible via respective web servers.

One or more reputation applications 234 allow users that transact, utilizing the network-based system 112, to establish, build, and maintain reputations, which may be made available and published to potential trading partners. Consider that where, for example, the network-based system 112 supports person-to-person trading, users may otherwise have no history or other reference information whereby the trustworthiness and credibility of potential trading partners may be assessed. The reputation applications 234 allow a user, for example through feedback provided by other transaction partners, to establish a reputation within the network-based system 112 over time. Other potential trading partners may then reference such a reputation for the purposes of assessing credibility and trustworthiness.

In order to make listings, available via the network-based system 112, as visually informing and attractive as possible, the marketplace applications 130 may include one or more imaging applications 236 utilizing which users may upload images for inclusion within listings. The one or more imaging applications 236 also operate to incorporate images within viewed listings. The imaging applications 236 may also support one or more promotional features such as image galleries that are presented to potential buyers. For example, sellers may generally pay an additional fee to have an image included within a gallery of images for promoted items.

The marketplace applications 130 may include one or more offer creation applications 238. The offer creation applications 238 allow sellers conveniently to author products pertaining to goods or services that they wish to transact via the network-based system 112. Offer management applications 240 allow sellers to manage offers, such as goods, services, or donation opportunities. Specifically, where a particular seller has authored or published a large number of products, the management of such products may present a challenge. The offer management applications 240 provide a number of features (e.g., auto-reproduct, inventory level monitors, etc.) to assist the seller in managing such products. One or more post-offer management applications 242 also assist sellers with a number of activities that typically occur post-offer. For example, upon completion of an auction facilitated by one or more auction applications 212, a seller may wish to leave feedback regarding a particular buyer. To this end, the one or more of the post-offer management applications 242 may provide an interface to one or more of the reputation applications 234, so as to allow the seller conveniently to provide feedback regarding multiple buyers to the reputation applications 234.

One or more dispute resolution applications 246 may provide mechanisms whereby disputes arising between transacting parties may be resolved. For example, the dispute resolution applications 246 may provide guided procedures whereby the parties are guided through a number of steps in an attempt to settle a dispute. In the event that the dispute cannot be settled via the guided procedures, the dispute may be escalated to a mediator or arbitrator.

One or more fraud prevention applications 248 may implement various fraud detection and prevention mechanisms to reduce the occurrence of fraud within the network-based system 112. The fraud prevention applications 248 may prevent fraud with respect to the third party or the client user in relation to any part of the request, payment, information flows, or request fulfillment. Fraud may occur with respect to unauthorized use of financial instruments, non-delivery of goods, and abuse of personal information.

One or more authentication applications 250 may verify the identity of a user, and may be used in conjunction with the fraud prevention applications 248. The user may, for example, be requested to submit verification of identity, an identifier upon making the purchase request. Verification may be made by a code entered by the user, a cookie retrieved from the device, a phone number/identification pair, a usemame/password pair, handwriting, or biometric methods, such as voice data, face data, iris data, finger print data, and hand data. In some embodiments, the user may not be permitted to login without appropriate authentication. The system (e.g., the FSP) may automatically recognize the user, based upon the particular network-based device used and a retrieved cookie for example.

The network-based system 112 itself, or one or more parties that transact via the network-based system 112, may operate loyalty programs and other types of promotions that are supported by one or more loyalty/promotions applications 254. For example, a buyer/client user may earn loyalty or promotions points for each transaction established or concluded with a particular seller/third party, and may be offered a reward for which accumulated loyalty points can be redeemed.

The application servers 128 may include messaging applications 256. The messaging applications 256 are responsible for the generation and delivery of messages to client users and third parties of the network-based system 112. Information in these messages may be pertinent to services offered by, and activities performed via, the payment applications 132.

Such messages, for example, advise client users regarding the status of products (e.g., providing “out of stock” or “outbid” notices to client users) or payment status (e.g., providing invoice for payment, Notification of a Payment Received, delivery status, invoice notices). Third parties may be notified of a product order, payment confirmation, or shipment information. Respective messaging applications 256 may utilize any one of a number of message delivery networks and platforms to deliver messages to users. For example, messaging applications 256 may deliver electronic mail (e-mail), instant message (IM), Short Message Service (SMS), text, facsimile, or voice (e.g., Voice over IP (VoIP)) messages via wired (e.g., the Internet), Plain Old Telephone Service (POTS), or wireless (e.g., mobile, cellular, WiFi, WiMAX) networks.

The payment applications 132 may include one or more payment processing applications 258. The payment processing applications 258 may receive electronic invoices from the merchants and may receive payments associated with the electronic invoices. The payment applications 132 may also make use of functions performed by some applications included in the marketplace applications 130.

For some exemplary embodiments, the marketplace applications 130 may include one or more reward applications 260. The reward applications 260 may evaluate accounts of participants and determine whether the participants qualify. It may be noted that the participants may be the sellers, the buyers, or anyone having an account with the network-based system 112. It may also be noted that the participants are associated with one or more properties that may be used by the reward applications 260 to determine qualification. For some exemplary embodiments, the one or more properties may include a rating. For example, the rating may be a seller's rating or a buyer's rating. Other properties may also be used by the reward applications 260 to determine qualification.

### Reward Application

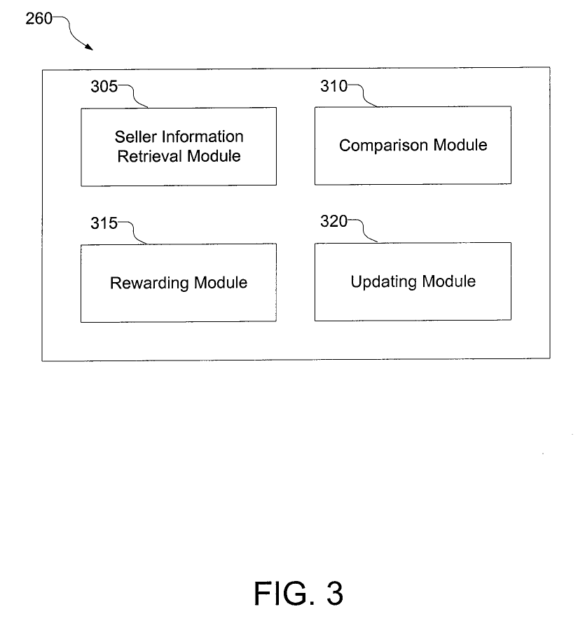

FIG. 3 illustrates a high-level diagram of the reward applications 260, in accordance with some exemplary embodiments. Merely as an example, the reward applications 260 may refer to the participants as the sellers. One skilled in the art will recognize that the description may also be applicable to other participants of the network-based system 112.

The reward applications 260 may include a seller information retrieval module 305 that communicates with the network-based system 112 illustrated in FIG. 1. The seller information retrieval module 305 may retrieve stored information about a seller. For some exemplary embodiments, the seller information retrieval module 305 may communicate with the reputation applications 234 to retrieve the seller's rating information. The seller's rating information may then be used to determine whether a seller is qualified for the rewards program.

The reward applications 260 may include a comparison module 310. The comparison module 310 may compare the seller's rating information with a set of criteria to determine whether a seller is qualified to be selected for the rewards program.

For some exemplary embodiments, other information besides or in addition to the seller's rating information may be used to determine whether the seller is qualified. For example, the set of criteria may include one or more of rating thresholds, current active listings, total listings, length of time registered as a participant, activities within a certain period of time, number of previous rewards received, number of active listings, number of total listings including active and closed listings, volume of sale (e.g., monetary volume) since the seller became a member or participant, volume of sales during a certain period of time, rating information during a certain period of time, total number of complaints, number of complaints during a certain period of time, and so on. The rating threshold may include, for example, low rating, medium rating, high rating, excellent rating, etc. The rating threshold may be numeric, alphabetic, or alphanumeric. For example, all sellers with positive ratings above 95% may qualify, and all sellers with positive ratings below 80% may not qualify.

The reward applications 260 may include a rewarding module 315. The rewarding module 315 may reward the seller selected by the comparison module 310. For some exemplary embodiments, a reward may be in the form of a listing promotion. For example, the rewarding module 315 may reward a selected seller by promoting one or more of the seller's active listings. Different techniques may be used to promote a listing. For example, a listing may be promoted by highlighting its title description. A listing may also be promoted by being placed in a certain section of the listing interface.

For some exemplary embodiments, the reward may be at no cost to the selected seller. For some other exemplary embodiments, the reward may in be in the form of a discount. The reward applications 260 may encourage sellers to continue to provide good services to the other participants so that they could qualify for the rewards, promote their businesses, and increase their revenues.

For some exemplary embodiments, a reward may be valid for a limited length of time (e.g., six hours). After the reward time has expired, the promoted listing may be returned to its normal non-promoted state, just like any other listings in similar categories. For some exemplary embodiments, a listing to be promoted may be determined by the seller, or it may be automatically determined by the rewarding module 315.

The reward applications 260 may work in conjunction with many other applications, such as the reputation applications 234, the offer creation applications 238, the offer management applications 240, and the post-offer management applications 242 (see FIG. 2).

### Fairness

For some exemplary embodiments, the comparison module 310 may be configured to use multiple selection criteria that would enable most of the participants to be evaluated for qualification. For example, a seller that has a high volume of active listings may be compared on a first set of criteria, whereas a seller that has a low volume of active listings may be compared on a second set of criteria. The second set of criteria may include criteria specifically designed to allow the low volume sellers to compete for qualification for the reward program with the high volume sellers. For example, a seller who has been registered with the network-based marketplace for a shorter length of time than another seller may be evaluated based on other criteria in addition to the registered time criteria.

The reward applications 260 may include an updating module 320. The updating module 320 may update a seller's reward qualification. The updating module 320 may alter a seller's qualification for the reward program, or it may end a seller's reward (e.g., it may end the promotion time of a qualified seller's listing) when a seller becomes disqualified for the reward. As an example, a seller may become disqualified upon receiving several new negative feedbacks that may lower the seller's rating. The comparison module 310 may periodically monitor the seller's rating to determine whether the seller remains qualified for the reward program. For some exemplary embodiments, the updating module 320 may alter the qualification for sellers that had not previously qualified when new information related to the seller has been received.

### Flow Diagram

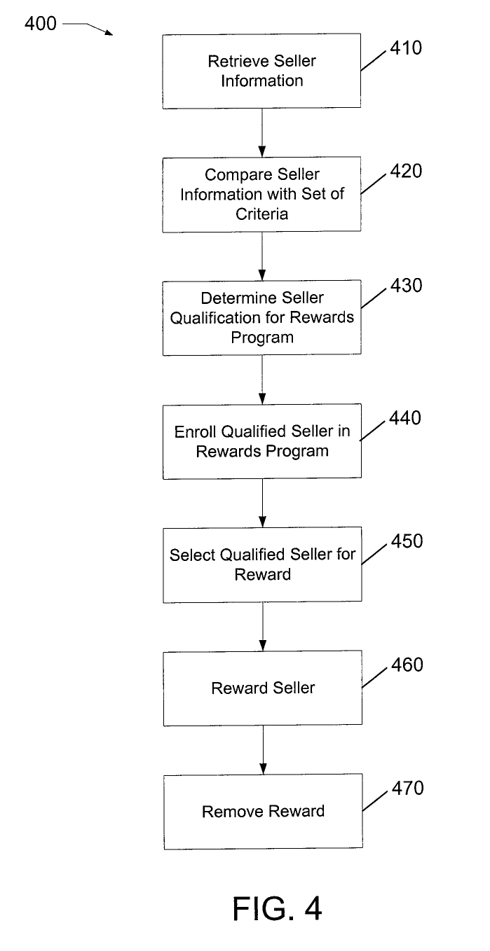

FIG. 4 is a flow diagram 400 illustrating an exemplary method for selecting sellers for the rewards program, in accordance with various exemplary embodiments. The flow diagram 400 may be performed by a computer system (not shown in FIG. 4 but described in detail in other portions of the specification herein) using software, hardware, or a combination of both. The flow diagram 400 may start at operation 410 where a seller's information is retrieved. For example, the seller's information may be retrieved from the databases 136 of FIG. 1. The seller's information may include rating information.

At operation 420, the retrieved information is compared with a set of predetermined criteria. The predetermined set of criteria used can include a seller's rating, feedback, reputation, past activities, current activities, activities within the last predetermined period of time, number of previous awards, etc. For example, a comparison could be made between a total percentage of negative feedback a seller has received and the maximum percentage allowable to qualify for the rewards program. For some exemplary embodiments, there may be a requirement of a minimum number of feedbacks to qualify. Thus, a seller who has total feedback amount of 100 and 5 negative feedbacks may qualify for the rewards program if the criterion for qualification (or rating threshold) is at least 95%. The criteria may be based on negative feedback or rating. For example, a seller may qualify if the negative feedbacks are less than 5% of the total feedbacks. At operation 430; a determination is made as to a seller's qualification for the rewards program based on a result of the comparison at operation 420.

A seller that does not qualify for the rewards program may become qualified in the future. For example, a seller that has a lower rating than the rating threshold may become qualified if his or her rating improves to beyond the rating threshold. It may be noted that this reward program does not prevent the sellers from paying normal fees to promote any of their listings.

At operation 440, a seller who qualifies for the rewards program is enrolled into the rewards program, the seller's qualification being determined in operation 430. At operation 450, a selection is made to reward a qualified seller. For example, the sellers that have been enrolled into the rewards program may be placed into a queue and the selection may be performed by choosing the next seller in the queue to be rewarded. In another example, a seller may be chosen from a pool of qualified sellers at random thus making the time in which a seller is qualified and selected unknown to both the seller and the system.

At operation 460, a seller that has been qualified for the rewards program, enrolled in the rewards program, and selected for a reward is rewarded. The reward may promote one or more of the seller's listings. The reward time may be fixed. The promoted listing may be included in a search result with an enhanced placement. As an example, a seller's listing may be displayed in a promotional section on a homepage of a system website and listed as a featured item for at certain time period such as, for example, six hours.

At operation 470, the reward is removed from the seller. The reward may be removed as a result of different variations of conditions. The removal procedure will be described in more detail, below.

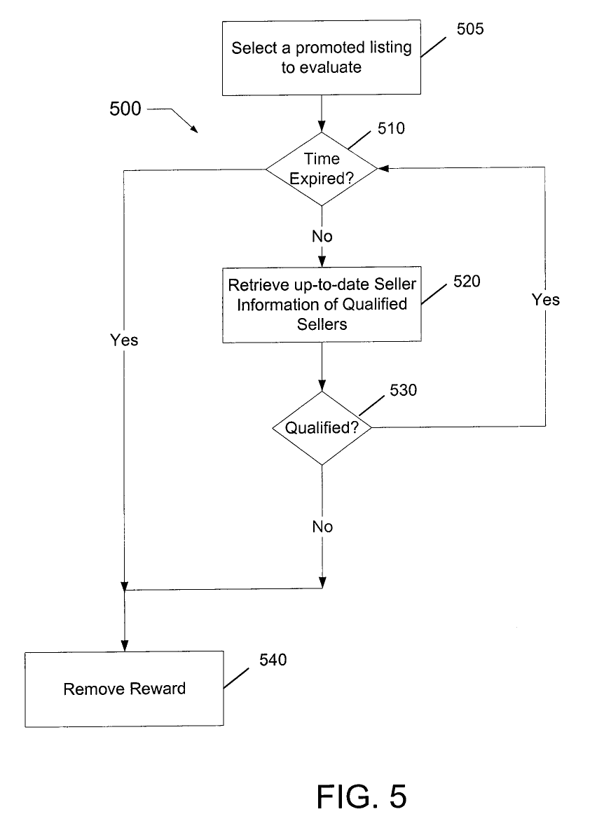

FIG. 5 is a flow diagram 500 illustrating an exemplary method for maintaining qualification in the reward programs, in accordance with some exemplary embodiments. The flow diagram 500 may be performed by a computer system (not shown in FIG. 5 but described in detail in other portions of the specification herein) using software, hardware or a combination of both. The flow diagram 500 may start at operation 505 where a promoted listing may be evaluated. At operation 510, a decision is made to determine whether the promotion for the listing has expired. As an example, a seller may be selected to promote a listing for a period of six hours. If that promotion period has not expired, the flow diagram may continue to operation 540 where the reward is removed. The promoted listing may then become a normal listing. If that promotion period has not expired, the flow diagram may continue to operation 520.

At operation 520, recently updated information regarding the seller is retrieved. At operation 530, the updated information is compared against a set of criteria to determine if the seller is still qualified. Some examples of criteria are described above. For example, a seller that has qualified for the rewards program may receive new negative feedback that may cause the seller to become disqualified for the reward program.

From operation 530, if the seller is still qualified for the rewards program based on the updated information, the flow diagram may continue back to operation 510. However, if the seller becomes disqualified, the reward is removed and the promotion ends and the reward is removed, as shown in operation 540.

### Exemplary Machine Architecture and Machine-Readable Medium

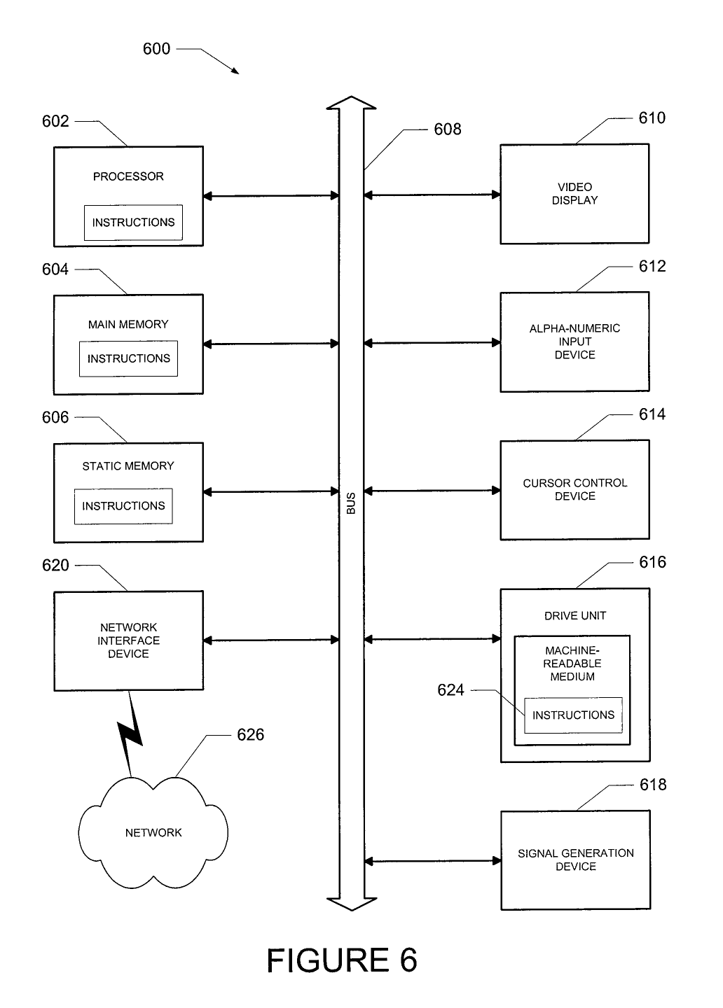

With reference to FIG. 6, an exemplary embodiment extends to a machine in the form of an exemplary computer system 600 within which instructions, for causing the machine to perform any one or more of the methodologies discussed herein, may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processor 601 (e.g., a central processing unit (CPU), a graphics processing unit (GPU) or both), a main memory 603 and a static memory 605, which communicate with each other via a bus 607. The exemplary computer system 600 may further include a video display unit 609 (e.g., a liquid crystal display (LCD) or a cathode ray tube (CRT)). The exemplary computer system 600 also includes an alpha-numeric input device 611 (e.g., a keyboard), a user interface (UI) navigation device or cursor control device 613 (e.g., a mouse), a disk drive unit 615, a signal generation device 617 (e.g., a speaker), and a network interface device 619.

### Machine-Readable Medium

The disk drive unit 615 includes a machine-readable medium 621 on which is stored one or more sets of instructions and data structures (e.g., software instructions 623) embodying or used by any one or more of the methodologies or functions described herein. The software instructions 623 may also reside, completely or at least partially, within the main memory 603 or within the processor 601 during execution thereof by the exemplary computer system 600; the main memory 603 and the processor 601 also constituting machine-readable media.

While the machine-readable medium 621 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks.

### Transmission Medium

The software instructions 623 may further be transmitted or received over a communications network 625 using a transmission medium via the network interface device 619 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to determine a reward in a network-based system, the method comprising:
retrieving a set of criteria relating to a user from criteria relating to a plurality of users stored in the network-based system, the user being identified to qualify for a reward program, the set of criteria being retrieved from one or more databases coupled to the network-based system;
using one or more processors within the network-based system to compare the set of criteria relating to the user and retrieved from the one or more databases to a predetermined set of criteria; and
based on a determination from a comparison of the set of criteria relating to the user that the user qualifies for the reward program:
promoting one or more listings of the user on the network-based system; and
monitoring updates to the set of criteria relating to the user to determine whether the user remains qualified for the reward program.

2. The method of claim 1, wherein the set of criteria relating to the user includes selecting information relating to a volume associated with listings the network-based system has hosted for the user.

3. The method of claim 2, wherein the volume information relates to a currency-based volume.

4. The method of claim 2, wherein the volume information relates to a quantity of listings volume.

5. The method of claim 2, wherein the volume information relates to a sold quantity volume.

6. The method of claim 1, wherein the set of criteria includes selecting information relating to rating information of the user.

7. The method of claim 1, further comprising selecting the reward program to expire after a predetermined amount of time has passed.

8. A machine-readable storage medium comprising instructions, which when executed by a machine, cause the machine to perform a method to determine a reward in a network-based system, the method comprising:
retrieving a set of criteria relating to a user from criteria relating to a plurality of users stored in the network-based system, the user being identified to qualify for a reward program, the set of criteria being retrieved from one or more databases coupled to the network-based system;
using one or more processors within the network-based system to compare the set of criteria relating to the user and retrieved from the one or more databases to a predetermined set of criteria; and
based on a determination from a comparison of the set of criteria relating to the user that the user qualifies for the reward program:
promoting one or more listings of the user on the network-based system; and
monitoring updates to the set of criteria relating to the user to determine whether the user remains qualified for the reward program.

9. The machine-readable storage medium of claim 8, wherein the set of criteria relating to the user includes selecting information relating to a volume associated with listings the network-based system has hosted for the user.

10. The machine-readable storage medium of claim 9, wherein the volume information relates to a currency-based volume.

11. The machine-readable storage medium of claim 9, wherein the volume information relates to a quantity of listings volume.

12. The machine-readable storage medium of claim 9, wherein the volume information relates to a sold quantity volume.

13. The machine-readable storage medium of claim 8, wherein the set of criteria includes selecting information relating to rating information of the user.

14. The machine-readable storage medium of claim 8, wherein the method further comprises selecting the reward program to expire after a predetermined amount of time has passed.

15. A system for determining a reward in a network-based environment, the system comprising:
a means for storing a set of criteria relating to a user;
a means for retrieving the set of criteria relating to the user from criteria relating to a plurality of users in the network-based environment, the user being identified to qualify for a reward program, the set of criteria relating to the user being retrieved from the means for storing;
a means for comparing the set of criteria relating to the user and retrieved from the means for storing to a predetermined set of criteria; and
based on a determination from the comparing of the set of criteria relating to the user that the user qualifies for the reward program:
a promoting means for promoting one or more listings of the user on the network-based environment; and
a monitoring means for providing updates to the set of criteria relating to the user to determine whether the user remains qualified for the reward program.

16. The system of claim 15, wherein the means for comparing is located with one or more application servers within the network-based environment.

17. The system of claim 16, wherein the one or more application servers comprise a payment application module to provide payment processing for goods or services sold by the user.

18. The system of claim 16, wherein the one or more application servers comprise an on-line auction module within the network-based environment.
